(19) United States
(12) Patent Application Publication
(10) Pub. No.: US 2009/0037178 A1
(43) Pub. Date: Feb. 5, 2009

(54) ANSWER AN INCOMING VOICE CALL WITHOUT REQUIRING A USER TO SPEAK

(76) Inventor: Yogesh K. MITTAL, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/830,145

(22) Filed: Jul. 30, 2007

(51) Int. Cl. G10L 13/00; H04Q 7/22

(52) U.S. Cl. 704/260; 455/412.1; 704/E13.001

(57) ABSTRACT

A system comprises a wireless transceiver and logic coupled to the wireless transceiver. The logic is adapted to answer a phone call from a calling party with an automated voice message and then, in the same phone call, to enable a user to have a two-way conversation with the calling party without requiring the user to speak.

### BACKGROUND

Receiving an in-coming phone call on a communication device can be problematic when the user is in an environment in which speaking would be inappropriate. For example, it may be inappropriate to answer a phone call on one's cell phone while in a movie or a meeting. However, the in-coming phone call may be important enough that the user would otherwise like to answer the call and talk to the calling party.

### BRIEF DESCRIPTION OF THE DRAWINGS

For a detailed description of exemplary embodiments of the invention, reference will now be made to the accompanying drawings in which:

FIG. 1 shows a system in accordance with various embodiments; and

FIG. 2 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

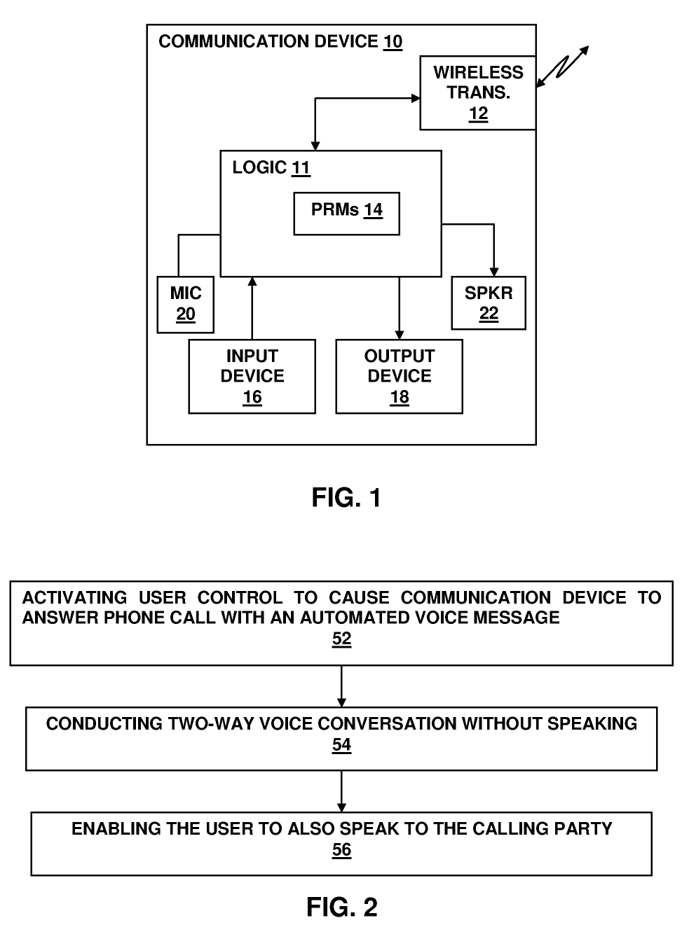

FIG. 1 shows a communication device 10 in accordance with various embodiments. As shown, the communication device comprises logic 11 coupled to a wireless transceiver 12, an input device 16, an output device 18, a microphone 10, and a speaker 22. The wireless transceiver 12 enables two-way wireless communications. In at least some embodiments, the communication device 10 comprises a cell phone or a personal digital assistant (PDA). In some embodiments, the logic 11 comprises a processor and memory. In various embodiments, the memory stores pre-recorded messages (PRMs) 14. The input device 16 may comprise a numeric keypad such as is used for a cell phone or a “QWERTY” keyboard such as is used on a PDA. The output device 18 comprises a liquid crystal display (LCD) or other type of display by which information can be shown to a user of the communication device 10. Speaker 22 may be integral into a housing of the communication device 10 or may comprise a separate ear piece coupled to the communication device 10 via a wire or a wireless communication link (e.g., Bluetooth).

The communication device 10 is capable of any one or more of various modes of operation. At least one mode of operation comprises a mode in which the communication device 10 can receive an incoming phone call and alert the user to the incoming phone call. Examples of such alerts comprise a ringing tone, a vibration of the device, or a blinking light or other form of visual feedback via output device 18. The user of the communication device may choose to answer such an incoming phone call and conduct a two-way conversation with the calling party without requiring the user to actually speak into the communication device 10. In this manner, the communication device 10 enables the user to actually answer the phone call without speaking.

In at least some embodiments, upon recognizing the receipt of an incoming phone call, a user activates the input device 16 to answer the incoming phone call with an automated voice message. A pre-defined button or key combination may be provided as part of input device 16 for this purpose. The automated voice message may be stored in memory in the logic 11. The automated voice message is transmitted to the calling party by the communication device 10. The automated voice message informs the calling party that the user of the communication device 10 wishes to conduct a two-way conversation with the calling party but can not speak aloud. The calling party conducts the conversation with the user of the communication device 10 by speaking into his or her own telephone, and such voice communications are received by the communication device 10 and presented to the user of communication device 10 via speaker 22 (e.g., an earpiece). The user of the communication device 10 can hear the calling party and can provide voice communications back to the calling party without, as explained herein, actually speaking aloud.

In at least one embodiment, the user of the communication device 10 selects one or more of the pre-recorded messages 14 to be transmitted back to the calling party. Examples of the pre-recorded messages 14 comprise “yes,” “no,” “let's talk later,” etc. The pre-recorded messages 14 may comprise both text and digitized speech equivalents of the messages. The logic 11 causes the text equivalent of the pre-recorded messages 14 to be displayed on output device 18. Using the input device 16, the user can select one or more of the pre-recorded messages 14 as displayed on output device 18 to be transmitted back to the calling party. In some embodiments, the user activates input device 16 to scroll through the list of pre-recorded messages being shown on output device 18. In other embodiments, the user selects a designator (letter, number, etc.) associated with each pre-recorded message shown on output device 18. Upon determining which pre-recorded message the user has selected, the logic 11 causes a speech signal corresponding to the pre-recorded message to be transmitted through the wireless transceiver 12 to the calling party.

In embodiments in which the logic 11 comprises or otherwise has access to pre-recorded message 14, the user of the communication device 10 can have the communication device 10 record the user's voice and store one more voice messages 14 as desired. In some embodiments, the communication device 10 comprises a recording mode of operation in which the user can record voice messages, tag each such recorded voice message with an identifier and a text equivalent (entered via input device 16).

In another embodiment, the user activates the input device 16 to type a message destined for the calling party. The logic 11 receives the typed message from the input device 16 and converts the typed message to a synthesized voice signal which is transmitted through the wireless transmitter 12 to the calling party. In such embodiments, the logic 11 thus comprises voice logic that synthesizes speech signals from text.

FIG. 2 shows a corresponding method. At 52, the method comprises activating a user control on the communication device 10 to cause the communication device to answer a phone call from a calling party with an automated voice message. At 54, the method comprises conducting a two-way voice conversation with the calling party without speaking. While the user of the communication device 10 need not speak in order to conduct a two-way conversation with a calling party, if desired the user of the communication device 10 could also speak to the calling party. Thus, at 56, the method also comprises enabling the user to also speak to the calling party. Thus, the communication device 10 permits a user to send voice communications to the calling party that are either generated by the logic 11 or are actual voice signals from the user itself.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a wireless transceiver; and
logic coupled to the wireless transceiver, said logic adapted to answer a phone call from a calling party with an automated voice message and then, in said phone call, to enable a user to have a two-way conversation with said calling party without requiring the user to speak.

2. The system of claim 1 wherein the logic enables the user to have the two-way conversation by transmitting pre-recorded voice messages to the calling party.

3. The system of claim 1 wherein the logic enables the user to have the conversation by enabling a user to select from among a plurality of pre-recorded voice messages.

4. The system of claim 1 wherein the logic transmits a pre-recorded voice message as selected by a user.

5. The system of claim 1 wherein the logic enables the user to have the two-way conversation by transmitting voice synthesized signals to said calling party.

6. The system of claim 1 further comprising an input device by which the user types a message for the calling party.

7. The system of claim 6 wherein the logic converts the typed message to a synthesized voice signal and transmits the synthesized voice signal to the calling party.

8. The system of claim 1 wherein said system comprises a device selected from a group consisting of a cell phone and a personal digital assistant (PDA).

9. The system of claim 1 wherein said logic enables a user to have the two-way conversation while speaking.

10. A system, comprising:
means for activating a user control on a communication device to cause the communication device to answer a phone call from a calling party with an automated voice message; and
means for conducting a two-way voice conversation with the calling party without speaking.

11. The system of claim 10 wherein the means for conducting the two-way voice conversation is also for enabling a user to select a pre-recorded voice message.

12. The system of claim 11 wherein the means for conducting the two-way voice conversation is also for transmitting the a pre-recorded voice message to the calling party.

13. The system of claim 10 wherein the means for conducting the two-way voice conversation is also for converting a typed message to a synthesized voice signal.

14. The system of claim 13 wherein the means for conducting the two-way voice conversation is also for transmitting the synthesized voice signal to the calling party.

15. The system of claim 10 further comprising means for enabling the user to also speak to the calling party.

16. A method, comprising:
activating a user control on a communication device to cause the communication device to answer a phone call from a calling party with an automated voice message; and
conducting a two-way voice conversation with the calling party without speaking.

17. The method of claim 16 wherein conducting the two-way voice conversation comprises selecting a pre-recorded voice message to be transmitted to the calling party.

18. The method of claim 16 wherein conducting the two-way voice conversation comprises converting a typed message to a synthesized voice signal.

19. The method of claim 18 wherein conducting the two-way voice conversation further comprises transmitting the synthesized voice signal to the calling party.

20. The method of claim 16 further comprising enabling the user to also speak to the calling party.
